(19) United States
(12) Patent Application Publication
(10) Pub. No.: US 2002/0182997 A1
(43) Pub. Date: Dec. 5, 2002

(54) Fiber reinforced mold polishing tool with abrasive tip

(76) Inventor: Lawrence W. Tiefenbach JR., Traverse City, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 10/157,720

(22) Filed: May 29, 2002

Related U.S. Application Data
(60) Provisional application No. 60/294,082, filed on May 29, 2001.

(51) Int. Cl. C09C 1/68; B24B 33/00

(52) U.S. Cl. 451/540; 51/307

(57) ABSTRACT

Described is a mold and die finishing tool comprising a multilayer composite shaft of with an abrasive tip integrally adhered thereto.

Also described is a method of manufacturing the tool by applying heat and pressure.

This application claims priority from Provisional Application No. 60/294,082, filed May 29, 2001, and entitled “Fiber Reinforced mold Polishing Tool With Abrasive Tip” which is incorporated by reference.

### TECHNICAL FIELD

This invention relates to a mold and die polishing and finishing tool.

### BACKGROUND OF THE INVENTION

Today, numerous plastic components are produced by plastic injection molding, which is a versatile process for forming intricate molded products having high dimensional accuracy. The injection molding process involves injecting a metered quantity of heated, plasticized material into a relatively cool mold or die. The solidified plastic part is then ejected and the process is repeated. This process is well known in the art and is described generally in the Tool & Manufacturing Engineers Handbook, Chapter 16, page 16-7.

Recently, there has been an increasing demand for lighter, stronger and less expensive plastic components. This has required parts to be made with less plastic thereby necessitating more reinforcement ribs with longer and thinner configurations than that previously used. The reinforcement ribs are very thin so as to give the plastic part its necessary strength and stiffness while minimizing distortion during the cooling process.

The reinforcement ribs in the molded parts correspond to slots or channels in the mold or die used to make those parts. As the parts become smaller and use less material, the slots or channels in the molds or dies are becoming increasingly narrow and deep making those slots or channels increasingly difficult to finish.

Molds of this type are typically made with hardened tool steels, such as those identified in the trade by the designations P20, H13, D2. The molds may be formed using various methods such as grinding, milling, drilling and electrical discharge machining (EDM), all of which leave surface imperfections or deposits requiring further refinement before the mold is satisfactory for use in the final molding process. Some examples of surface imperfections include cutter marks and scratches of varying depths left from cutting wheels. Additionally, layers of recast, splattered metal of varying thickness are left behind by the EDM process. In order to make a mold that will perform adequately, the mold maker or polisher must remove all of these surface imperfections while maintaining strict dimensional tolerances.

One of the products previously used to obtain an acceptable surface finish is a conventional resin treated vitrified bonded abrasive mold polishing stone, such as that being sold by Boride Engineered Abrasives of Traverse City, Mich. under the designation AM-8 or AS-9. In use, these conventional stones are ground extremely thin and shaped to match the configuration of the slot to be polished. These conventional stones are very effective at removing the EDM recast layer. However, the disadvantage of these products is that because of their brittle nature, they fracture quite easily when they are made thin enough to fit into a slot.

Another product designed for finishing hard to reach areas such as deep and narrow mold slots is marketed under the name Super Stone disclosed in U.S. Pat. No. 5,233,794 to Nippon Steel Corporation. The Super Stone is made of a composite material consisting of unidirectional ceramic fibers in a resin bond. The ceramic fibers are extremely hard, like abrasive grit, and their fiber tips are effective at cutting steel. This product is very strong and does not suffer from the fracturing problem of the conventional stone described above. However, the Super Stone has the disadvantage of considerably less cutting ability than conventional stones. The Super Stone loses cutting ability because the ceramic fibers must have a fairly significant contact angle so the fiber tips can address the work piece adequately. Since slots are generally thin and deep, the Super Stone's cutting performance is poorer on the slot faces, as compared to the conventional stone. Despite its shortcomings, the strength advantages associated with the Super Stone often outweigh the cutting difficulty, making it the current tool of choice.

Because of the lack of a good all-around product, toolmakers have resorted to affixing emery paper, diamond foil and other abrasive papers, stones or cloth to existing tools or plastic shafts as is described by Fogarty in his article Mold Polishing Technique: Evolution or Revolution, Modem Mold & Tooling, November, 1999. The use of cloth, diamond foil and abrasive papers in these instances suffer from the drawback of being a time consuming and temporary solution. The mold maker must spend a great deal of costly shop time properly affixing the abrasive to an existing tool, thereby increasing the cost of the finishing process. To ensure that the existing tool with the addition of the abrasive can fit into a very narrow mold slot, the abrasive must be very thin and therefore wears out quickly. Hence, the entire tool modification process must be repeated. Alternatively, the shaft is very thin and therefore has low rigidity. Further, the addition of stones to a plastic shaft generally results in a product that is too thick for polishing truly narrow slots.

The present invention seeks to solve the problems associated with the prior art. It is a mold and die polishing or finishing tool that successfully finishes the thin slots or other difficult to reach areas in plastic injection or other molds. It maintains strength and improves stiffness relative to the fiber composite Super Stone with the cutting action of a conventional or super abrasive. In other words, the tool of the present invention is both strong enough to solve the fracturing problem associated with the conventional stone and stiff enough to solve the cutting problems associated with the Super Stone by applying sufficient down force onto a thin abrasive. This thin abrasive, utilizing metal bonded super abrasives like diamond, enhances the performance and the life of this effective tool.

The entire shaft is completely machinable with ordinary conventional grinding wheels even with the bonded diamond adhered thereto. This gives the mold polisher the ability to shape the tip as needed for a specific job and it allows for truing the tip of the tool as it wears.

None of the references or known prior art describes a mold polishing tool having a composite multilayer shaft with an abrasive tip permanently adhered thereto such that the tool has the ability to cut effectively, the strength to prevent fractures and the stiffness to provide down force on the abrasive with minimal contact elsewhere on the mold.

### SUMMARY OF THE INVENTION

Described is a mold polishing tool having a multilayer composite shaft made of graphite fibers, ceramic fibers, glass fibers and bronze metal mesh all impregnated with epoxy and an abrasive tip of a metal bonded diamond or other thin abrasive adhered thereto.

Also described is a method of manufacturing the tool comprising

a. providing at least a pair of prepreg filler layers;

b. providing at least one ceramic fiber prepreg layer;

c. providing at least a pair of prepreg high modulus fiber layers surrounding the filler layers;

d. providing at least a pair of bronze cloth prepreg layers as a protective layer or coating to the outermost fiber layer except in the tip area;

e. providing an epoxy impregnated abrasive tip to the tip area of the outermost fiber layer;

f. simultaneously applying heat and pressure to the layers thereby softening the resin matrix in the prepreg, coating, abrasive tip and concomitantly bonding the layers together.

### BRIEF DESCRIPTION OF THE DRAWINGS

FIG. 1 is a top view of the mold polishing tool of the present invention.

FIG. 2 is a side view of the mold polishing tool of the present invention

FIG. 3 is an exploded view of the mold polishing tool in the preferred embodiment.

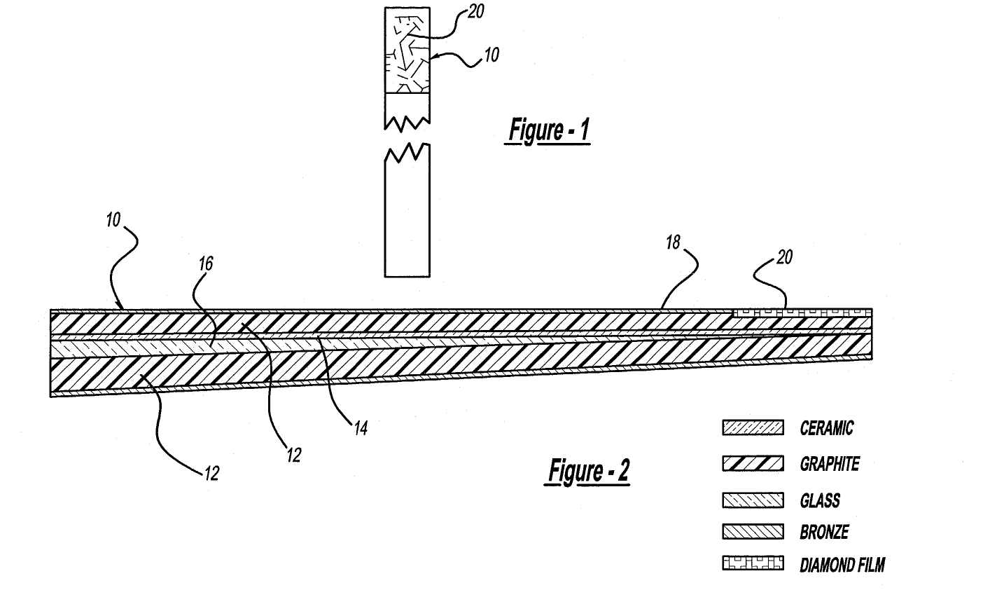

### DESCRIPTION OF PREFERRED EMBODIMENT

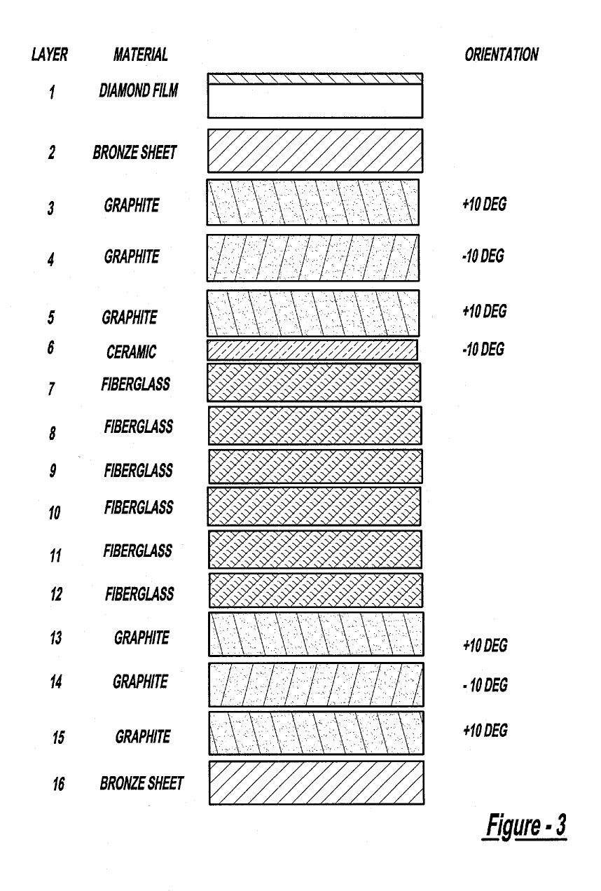

The present invention is a mold polishing tool having a composite shaft (10) with an abrasive tip (20) permanently adhered thereto. As seen clearly in FIG. 2, the shaft (10) is a multilayer composite of oriented high modulus unidirectional graphite fibers (12), oriented unidirectional ceramic fiber (14), glass fabric (16), and bronze metal mesh (18) impregnated with epoxy resins. The high modulus graphite fibers (12) give the shaft superior strength and stiffness, while allowing for a very thin cross section. However, graphite fibers are expensive. Therefore, a tool made completely of high modulus graphite fibers would be very costly to make and therefore would lack marketability. In the present invention, glass fibers (16) in the form of a fabric are used as a means to thicken the shaft thereby displacing the graphite from the shaft's centroid and increasing its strength and stiffness. The glass fabric (16) is far less expensive than the high modulus graphite (12). While the glass fibers (16) themselves add little to the shaft's stiffness, by occupying the area of the midplane and moving the graphite further from the centroid they increased the moment of inertia and flexural stiffness exponentially at minimal cost. The ceramic fiber layer (14) serves to toughen the tip and minimize the wear of shaft from pounding motion again the bottom of slot. The outermost layers of the shaft are made of a bronze metal mesh (18). This gives the shaft (10) protection from abrasion by the unpolished surfaces or the sharp edge of the slot surface, while not being sufficiently hard to result in any unintentional cuts or scratches to the surfaces of the slot being finished. Presently, two epoxy resins, Fiberite® 977-2 from Hexcel Corporation in the graphite prepreg, and abrasive tip and Aldila ABS-19 from Aldila, Inc. in the glass fabric (16), ceramic fiber (14) prepreg and bronze cloth (18) provide the matrix for the multilayer composite blank (ABS stands for Aldila Bubble Shaft).

As seen in FIG. 2, the shaft (10) of the present invention is designed with a taper such that the working tip portion of the shaft is relatively thin as compared to the opposing end of the shaft (10). It is to this relatively thin portion of the shaft (10) that an abrasive material is adhered thereby forming the abrasive tip. Presently, the preferred thickness of the relatively thin portion of the shaft is 0.010-0.035 inches, although other thicknesses will work depending ultimately upon the size and depth of the mold slot versus the number and thickness of the graphite reinforcing layers. This tapered cross section gives the tool added stiffness where it is being held by the tool maker or clamped into the tool holder, while allowing the working tip of the tool to remain thin enough to fit in the tight slots of the mold or die. It also allows for the overall thickness to remain minimal with the addition of the bonded abrasive (20) at the tip. The length and width of the shaft may vary, depending upon the toolmaker's need and the dimensions of the particular area to be finished.

The present invention employs a unidirectional prepreg tape of graphite fibers (12). Prepreg, as used herein, means B-staged resin matrix containing fibers therein. In other words, it is reinforcing fibers that are pre-impregnated with a B-staged resin system. The use of a unidirectional prepreg of graphite fibers (12) oriented at small angles to the length axis gives the tool its greater strength and stiffness along the length of the tool where reinforcement is necessary due to the flexural forces exerted by the tool maker during finishing or polishing. Various orientations and forms (unidirectional, fabric, chopped filing etc.) may be used for reinforcement, but the ±10° orientation shown in FIG. 3 is preferred because it maximizes strength and stiffness along the length while providing for some strength across the width of the shaft. The preferred graphite fiber is M60J (6K) graphite fiber manufactured by Toray of Ehime Japan. This is one of the highest modulus polyacrilonitrile (PAN) based graphite fibers on the market today having an axial tensile modulus of 85.3×10⁶ psi, which gives the shaft the necessary stiffness with the minimum prepreg tape thickness. Presently, the preferred thickness is 4-6 layers (0.0025 inch-thick each) at the tip. One main problem that this invention solves is being a rigid, strong tool for reaching in and polishing plastic injection mold slots down to 0.015 in. The resin system of this prepreg is Fiberite® 977-2 epoxy from Hexcel Corporation. The preferred formulation is a prepreg tape having a fiber area weight of 61.1±3.5 (g/m²) and a resin content of 43±2 wt %. Other high modulus fiber reinforcement may be utilized. Examples include all other types of polyacrilonitrile (PAN) and pitch-based graphite fibers, as well as silicon carbide, alumina, and others.

The preferred ceramic fiber (14) is a unidirectional prepreg tape with the ABS-19 epoxy from Aldila. The fiber is Nextel® VN610 by 3M. Fiber area weight is 418 and resin content is33%. The fiber has diameter of 12 mm. 1 ply-0.0091.

The preferred glass fiber filler (16) is a bi-directional prepreg fabric of E-glass fiber having a weave style designated as 1522 by Clark-Schwebel, Inc. The fabric is remarkable only in that it is thin (about 0.005 in per ply) and lends itself to tailoring the thickness of the shaft. The preferred resin is an ABS-19 epoxy produced by Aldila, Inc. of Poway, Calif. There are many other fillers that could be used. Examples include Aramid (Kevlar™ produced by Dupont), low-modulus graphite fabrics in woven or non-woven form, foam, paper, or other less expensive core materials which are known to those skilled in the art.

As seen in FIGS. 2 and 3, the outermost layer of the shaft (10) consists of a protective layer or coating (18), preferably comprising bronze cloth. While the composite shaft (10) is extremely strong and rigid, it is soft and won't cut steel. This particular property provides a benefit over steel files or other hard tools where one slip may cause an inadvertent scratch requiring the mold polisher to start the polishing process again. However, this same property provides surfaces that can be cut by the sharp edges of plastic injection molds. Once the outer high modulus graphite layers are cut, the tool can fracture. To fix the abrasion problem, bronze cloth is preferably co-cured with the outer surfaces of the composite shaft panels.

Bronze was chosen because it is much softer than steel, but resists abrasion better than graphite. Bronze cloth is readily available in very fine mesh sizes that result in thin layers. The preferred mesh is distributed by F. P. Wire Smith Co. of Northlake, Ill., and is designated as “200”. This product has a wire diameter of 0.0025 inch for a total thickness of 0.004 inch. The bronze cloth is impregnated with the ABS-19 epoxy. The protective coating is preferably co-cured with the blank. However it could be post-bonded with a two-part paste adhesive like Hysol EA-9394 made by Hysol Aerospace Products and distributed by Rudolph Bros. of Canal Winchester, Ohio. If the post-bonding method is used, the bronze cloth would be used in its raw form (not impregnated). Other bonds could include using a film adhesive or electroless plating. Still other methods include using a B-staged film adhesive from Hexcel or other adhesive suppliers. The porosity of the cloth increases the mechanical bond to the other layers. Other materials could be used as a surface protectant, including, thick polymer films, solid brass shim stock, paper, fabrics, gel coat and others known to those skilled in the art.

The abrasive tip (20) of the present invention must: (1) be extremely hard and cut steel and/or the EDM recast layer very quickly, (2) have a long life, and (3) be relatively thin and in some cases extremely thin. The preferred material for the abrasive tip (20) is a nickel bonded diamond cloth material available from KGS Diamond of Denis, Switzerland. The preferable material is in its raw state without any backing material. This material meets all of the requirements stated above, bonds easily to the shaft material, and is cost effective. The diamond film is preferably adhered to the shaft by first impregnating with ABS-19 epoxy and co-cured. It could also be post-bonded using Hysol EA 9394 at the same time as the bronze cloth after the blank shaft has been made. Either method allows epoxy to soak into the metallized cloth and fill the areas around the diamond “islands” making an integral mechanical bond with the shaft.

The arrow shaped interlocking pattern of the diamond used in the abrasive tip (20) serves to add some additional strength to the tip (the thinnest part of the shaft (10)) and creates a smooth scratch pattern in the steel being polished. This allows the mold polisher to get the final draw pattern necessary to ensure that plastic releases from the tool slots. Other diamond products could be used but there would be some compromise with the requirements of life, speed of cut, or scratch pattern delivered. Other non-diamond abrasives could also be used. They include vitrified or resin bonded CBN or traditional abrasives like Al₂O₃ or SIC that are either vitrified or resin bonded and others known to those skilled in the art.

Presently, in the preferred embodiment, the tool of the present invention is fabricated with three or more layers of the unidirectional, high modulus graphite fiber (12) prepreg laid at a ±10-degree bias to the length axis of the shaft. (See FIG. 3) The core preferably has 3 or more warp-aligned layers of glass fiber fabric (16). One or more layers of ceramic fiber (14) prepreg-10 degree bias followed by another three or more layers of graphite fibers (12) are laid on the opposite side of the glass core (16) in the same fashion as the initial graphite layers. One layer of bronze cloth (18) or other protective coating is used as the outermost layer covering. The graphite (12), ceramic (14), bronze (18), and glass (16) prepreg materials are laid up in such a fashion that two sheets are made having a length of 4-8 inches, a width of 12 inches a lay-up oriented to the length of the axis of the shaft as follows: +10, −10, +10, −10, 0, 0, 0, −10 ,+10 , −10 and a tapered thickness created by the “dropping off” or ending of the glass layers and possibly some of the graphite layers at incremental lengths from the tip. The thin tip portion of the shaft (10) will range in thickness from 0.010 to 0.035 inch and the thick opposing end will range from 0.030-0.070 inch. The graphite fibers (12) run the entire 4-8 inch length. The glass fibers (16) are the filler that gives the opposing end the added thickness and concomitantly more strength. The bronze cloth (18) is the outermost sheet. It only extends to the point where the abrasive tip (20) is added. The sheets are made such that the tip face outward and the butt ends touch.

The tool product is laminated together using heat and pressure. The tooling for this process consists of a 2×12×12 inch slab and a ¼×12×12 inch slab (top) of a tool steel or aluminum that was blanchard ground flat and parallel to 0.0005 in. A pressure pad material is applied to both inside surfaces. A non-silicone rubber like Airpad from Airtech International works well. The Airpad should be cured by heating to 350 F. while applying a pressure of 100 psi (7.2 tons of force) onto the tooling.

The product is arranged in the center of the press tooling. A non-silicone rubber cap surrounds the top and perimeter of the lay-up to provide uniform pressure to the tapered shaft and to prevent excess resin escaping during pressing.

A 0.001-inch thick release film is applied (WL50-200, Airtech International) to the bottom steel punch containing the cured pressure pad material. To this a 0.003 release fabric is applied (Release Ease 234 TFP, Airtech International). The same is done to the top steel punch.

The tooling is placed is a press that has heated platens. The tooling setup is placed in the press and the platens brought to the point of touching and a 5-ton load is applied. A program is used that takes the temperature within the setup to 350° in one and one-half hour and holds it at 350° F. for 3 more hours, The pressure is released, the tooling removed and the parts (sheet) are stripped.

After the resulting laminate has cooled to room temperature, parts of various lengths and widths may be cut therefrom. The tool product is then painted and finally cut to appropriate lengths.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A polishing tool comprising a multiplayer composite shaft and a tip. Said multilayer composite shaft having:
a. at least one filler layer;
b. at least one ceramic fiber layer disposed on said filler layer;
c. at least a pair of high modulus fiber layers, at least one of said pair of fiber layers disposed on said filler layer and at least one of said pair of fiber layers disposed on said ceramic fiber layer; and
d. a protective coating disposed on said high modulus fiber layer.

2. A polishing tool according to claim 1, wherein said tool has at least a pair of filler layers.

3. A polishing tool according to claim 1, wherein said shaft tapers along the longitudinal axis from a relatively thick end to a relatively thin end.

4. A polishing tool according to claim 3, wherein said tip is disposed on said relatively thin end of said shaft.

5. A polishing tool according to claim 4 wherein said tip is abrasive.

6. A polishing tool according to claim 5, wherein said abrasive tip comprises diamond cloth.

7. A polishing tool according claim 1, wherein said layers are secured together by an adhesive resin matrix.

8. A polishing tool according to claim 1, wherein said protective coating comprises a layer of bronze cloth.

9. A polishing tool according to claim 1, wherein said high modulus fiber layers comprise unidirectional prepreg tape of graphite fibers.

10. A polishing tool according to claim 1, wherein said filler layer comprises a bi-directional prepreg fabric of E-glass fibers.

11. A polishing tool according to claim 1, wherein said ceramic fiber layer comprises a unidirectional prepreg tape of ceramic fibers.
